(19) United States
(12) Patent Application Publication
(10) Pub. No.: US 2026/0164308 A1
(43) Pub. Date: Jun. 11, 2026

(54) OPEN END TO END DYNAMIC NETWORK MANAGEMENT SYSTEM

(71) Applicants: AT&T Intellectual Property I, L.P., Atlanta, GA (US); AT&T Technical Services Company, Inc., Vienna, VA (US)

(72) Inventors: Thomas W. Henderson, Alpharetta, GA (US); David Ross Beppler, Duluth, GA (US); Daniel Vivanco, Ashburn, VA (US); Douglas McElroy, Lufkin, TX (US)

(73) Assignees: AT&T Intellectual Property I, L.P., Atlanta, GA (US); AT&T Technical Services Company, Inc., Vienna, VA (US)

(21) Appl. No.: 18/975,829

(22) Filed: Dec. 10, 2024

(51) Int. Cl. H04W 28/18; H04W 28/08

(52) U.S. Cl. CPC H04W 28/18; H04W 28/08

(57) ABSTRACT

Aspects may include identifying parameter attribute information for functions associated with CM, PM, and/or FM performed in a RAN which is associated with a CU, a DU, an RU and/or one or more applications; comparing the parameter attribute information; adjusting, according to the one or more comparisons, the parameter attribute information resulting in normalized parameter attributes by applying a mapping matrix (or other analysis technique or data structure) to at least a portion of the parameter attribute information; and providing the normalized parameter attributes to the CU, the DU, the RU, and/or the one or more applications, which in some embodiments enable a subsequent function(s) to be performed for the CM, the PM, and/or the FM. Other embodiments are disclosed.

### FIELD OF THE DISCLOSURE

The subject disclosure relates to an open end to end dynamic network management system.

### BACKGROUND

Current network management systems face significant challenges in managing various information such as parameters and alarms, particularly across equipment that can be sourced by multiple vendors. The lack of standardized naming conventions and parameter attributes complicates the normalization of these parameters, making the normalization process difficult for products to interoperate effectively. Vendors often use different interpretations of parameters, leading to misalignment and increased complexity in managing these parameters across various network elements.

Existing solutions require manual intervention which is labor-intensive, prone to errors, and can be reactive in nature. This manual process also introduces delays in the deployment and operation of applications that rely on accurate and consistent parameter mappings for optimal performance. The absence of a standardized or normalized view of alarms further exacerbates the problem, making management and response to faults challenging in a timely manner.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of a system functioning within the communication network of FIG. 1 in accordance with various aspects described herein.

FIG. 2D is a block diagram illustrating an example, non-limiting embodiment of a system functioning within the communication network of FIG. 1 in accordance with various aspects described herein.

FIG. 2E is a block diagram illustrating an example, non-limiting embodiment of information (e.g., which can be used in a user interface or otherwise part of the system and methodology described herein) functioning within the communication network of FIG. 1 in accordance with various aspects described herein.

FIG. 2F is a block diagram illustrating an example, non-limiting embodiment of information (e.g., which can be used in a user interface or otherwise part of the system and methodology described herein) functioning within the communication network of FIG. 1 in accordance with various aspects described herein.

FIG. 2G is a block diagram illustrating an example, non-limiting embodiment of information (e.g., which can be used in a user interface or otherwise part of the system and methodology described herein) functioning within the communication network of FIG. 1 in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a dynamic and automatic mapping matrix for Configuration Management (CM), Performance Management (PM), and/or Fault Management (FM) information such as parameters, alarms or other data within the Open Radio Access Network (ORAN) Service Management and Orchestration (SMO) framework. This mapping matrix can address or mitigate any misalignment of CM/PM/FM information including parameters and alarms across various RAN, core and transport vendors, which is a significant challenge in the interoperability of ORAN products and services.

In one or more embodiments, the system and methodology can provide dynamic and automatic mapping. For example, logic can be provided including a mapping matrix or other functionality that dynamically and automatically detects misaligned CM/PM/FM information (e.g., parameters, counters and/or alarms) such as from rApps (radio applications) to the RAN nodes, transport, and core elements across different vendors. This can include adjustments (e.g., naming normalization or translations) or other mitigating techniques to be applied to misaligned information. This ensures automatic mapping and alignment of these parameters normalized to all vendors with version control across various new releases (e.g., 3GPP, ORAN, etc.).

In one or more embodiments, the system and methodology can provide attribute table and reliability indexing. For example, an attribute table can be utilized to define CM/PM/FM information (e.g., parameters and alarms), including attributes such as name, parameter range, parameter value, parameter units, technology, specification, version, hardware, vendor, and/or vendor model. A reliability index can be used to determine the accuracy of the mapping and translations of this information such as parameters and alarms across all vendors.

In one or more embodiments, the system and methodology can provide Artificial Intelligence/Machine Learning (AI/ML) integration. For example, AI/ML history-based attribute parsing and mapping can be employed, which allows for the automatic mapping and translation of parameters even when there is not a 100% match. This feature can be user-configurable, such as based on a Reliability Index Score, and/or can be used for generating reports for manual evaluation and translation, such as when necessary or desired.

In one or more embodiments, the system and methodology can provide normalization across vendors. For example, by normalizing CM/PM/FM parameters and alarms across different vendors, rApps and/or xApps (e.g., cross applications) can function correctly without manual intervention, regardless of the specific vendor implementations. This significantly reduces the laborious tasks involved in managing and mapping these parameters and alarms, saving time and operational costs.

In one or more embodiments, the system and methodology can provide enhanced interoperability. For example, the interoperability facilitates operation of ORAN products by providing a standardized and normalized view of CM/PM/FM parameters and alarms, which is crucial for the seamless operation of rApps and xApps across different vendor products. This normalized or standardized view can be for users that are reviewing information, systems that are analyzing information (e.g., performing tasks in response to a particular alarm that has been issued where the naming convention of the alarm is normalized so that the task is triggered), or for other techniques that improve operation of the communications network including enhancing performance. In one embodiment, a normalized view can be provided across CM/PM/FM data. Overall, the system and methodology provide a comprehensive solution to the challenges of parameter misalignment in ORAN environments, enhancing the efficiency, reliability, and scalability of network management and orchestration. Other embodiments are described in the subject disclosure.

One or more aspects of the subject disclosure include a method comprising identifying, by a processing system including a processor, parameter attribute information for functions associated with at least one of CM, PM, or FM performed in a RAN, where the CM, PM or FM are associated with at least one of a Central Unit (CU), a Distributed Unit (DU) or a Radio Unit (RU) of the RAN and with one or more applications. The method can include comparing, by the processing system, portions of the parameter attribute information, where each of the portions are associated with different ones of the CU, DU, or RU or are associated with different ones of the one or more applications resulting in one or more comparisons. The method can include adjusting, by the processing system and according to the one or more comparisons, the parameter attribute information resulting in normalized parameter attributes, where the adjusting includes applying a mapping matrix to at least a portion of the parameter attribute information. The method can include providing, by the processing system, the normalized parameter attributes to at least one of the CU, the DU, the RU, or the one or more applications to enable a subsequent function to be performed for the at least one of the CM, the PM, or the FM.

One or more aspects of the subject disclosure include a device, comprising a processing system including a processor; and a memory that stores executable instructions that, when executed by the processing system, facilitate performance of operations. The operations can include receiving data from an application associated with at least one of CM, PM, or FM performed in a RAN, where the CM, PM or FM are associated with at least one of a CU, a DU or an RU of the RAN. The operations can include identifying parameter attribute information from the data by applying AI modeling to the data. The operations can include comparing portions of the parameter attribute information resulting in one or more comparisons; and adjusting, according to the one or more comparisons, the parameter attribute information resulting in normalized parameter attributes, where the adjusting includes applying a mapping matrix to at least a portion of the parameter attribute information. The operations can include providing the normalized parameter attributes to at least one of the CU, the DU, or the RU to enable a subsequent function to be performed for the at least one of the CM, the PM, or the FM.

One or more aspects of the subject disclosure include a non-transitory machine-readable medium, comprising executable instructions that, when executed by a processing system including a processor, facilitate performance of operations. The operations can include receiving data from at least one of a CU, a DU or an RU of a RAN, where the data is associated with CM, PM, or FM performed in the RAN. The operations can include identifying parameter attribute information from the data by applying AI modeling to the data; and comparing portions of the parameter attribute information resulting in one or more comparisons. The operations can include adjusting, according to the one or more comparisons, the parameter attribute information resulting in normalized parameter attributes, where the adjusting includes applying a mapping matrix to at least a portion of the parameter attribute information; and providing the normalized parameter attributes to a plurality of applications to enable subsequent functions to be performed for the at least one of the CM, the PM, or the FM, where the plurality of applications include at least one of rApps or xApps.

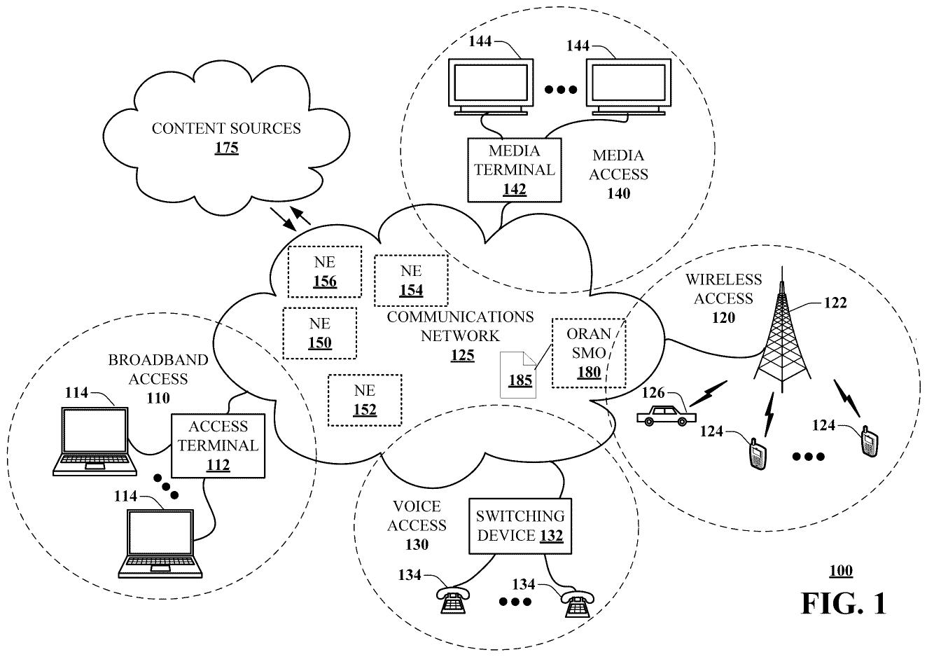

Referring now to FIG. 1, a block diagram is shown illustrating an example, non-limiting embodiment of a system 100 in accordance with various aspects described herein. In one or more embodiments, system 100 can include an SMO 180 (e.g., an ORAN SMO) responsible for the overall management, orchestration, and automation of the RAN elements and services. The SMO 180 can play a pivotal role in ensuring that the various components of the ORAN ecosystem work together seamlessly and efficiently. For example, the SMO 180 can perform service management. The SMO 180 manages the lifecycle of RAN services, including their creation, modification, and/or deletion. It ensures that services are delivered according to predefined policies and Service Level Agreements (SLAs). The SMO 180 can perform orchestration. The SMO 180 orchestrates the deployment and configuration of RAN elements, such as O-CUs, O-DUs, and/or O-RUs. It coordinates the interactions between these elements to ensure optimal or improved performance and resource utilization.

The SMO 180 can perform automation. The SMO 180 automates various RAN management tasks, such as configuration management, performance management, and fault management. Automation helps reduce the operational complexity and manual effort required to manage the RAN. The SMO 180 can perform configuration management. The SMO 180 handles the configuration of RAN elements, ensuring that they are set up correctly and consistently. It manages configuration parameters (e.g., CM parameters) and applies changes as needed to optimize network performance.

The SMO 180 can perform performance management. The SMO 180 monitors the performance of RAN elements and services. It collects and analyzes performance data (e.g., PM data) to identify trends, detect anomalies, and ensure that the network meets performance targets. The SMO 180 can perform fault management. The SMO 180 detects, reports, and manages faults in the RAN. It generates alarms for various fault conditions and initiates corrective actions to resolve issues and maintain network reliability.

The SMO 180 can perform integration with the RAN Intelligent Controller (RIC), which can include the Non-Real-Time RIC (Non-RT RIC) and the Near-Real-Time RIC (Near-RT RIC). The RIC hosts rApps and/or xApps that provide advanced network management and optimization capabilities. The SMO 180 coordinates with the RIC to ensure that these applications can effectively manage the RAN. The SMO 180 can perform vendor-agnostic management. The SMO 180 provides a vendor-agnostic management interface, allowing it to manage RAN elements from different vendors. This can be in certain scenarios essential for achieving the interoperability and openness that are central to the ORAN vision.

The SMO 180 can perform policy management. The SMO 180 enforces policies related to RAN operations, such as quality of service (QoS) policies, security policies, and resource allocation policies. It ensures that these policies are consistently applied across the network. Overall, the ORAN SMO 180 is a key enabler of the ORAN architecture, providing the management, orchestration, and automation capabilities needed to create an open, interoperable, and efficient RAN ecosystem.

In one or more embodiments, a mapping function 185 (which can include or make use of a mapping matrix) can dynamically and/or automatically map and translate (or otherwise align) CM, PM, and/or FM parameters, data, alarms and/or other information across various vendor products within a network or system including an ORAN environment. The mapping function 185 is illustrated as being located at the SMO 180, but can be executed at various locations and utilizing various components including in a centralized fashion, remote fashion, distributed fashion, cloud-services fashion, and so forth.

As an example of function 185, a mapping matrix (or other mapping and translating functionality) can be employed that normalizes particular parameters, data, alarms and/or information, ensuring interoperability and seamless communication and interaction between hardware and/or software components including those of different vendors.

For example, function 185 can perform dynamic and automatic mapping. For example, a method can be implemented that dynamically and automatically detects misaligned CM, PM, and FM information including parameters, counters and alarms from various vendors and maps them to a normalized view (or normalized attribute representation). This eliminates the need for manual intervention and reduces the complexity and time required for managing this information.

As another example, function 185 can perform AI/ML integration. For example, AI (which can include ML) can be utilized to parse, map, and/or translate particular information including parameters, counters and alarms such as based on historical data and attribute matching. This ensures that the mapping process is adaptive and can handle new vendors and updates efficiently. This also allows for mapping and translation in real-time or near-real-time so that the network performs efficiently and in an improved manner.

As another example, function 185 can generate or otherwise use a reliability index or value to rank and score the accuracy or confidence associated with information (e.g., parameter, counters, alarms) mappings. This index helps in determining the confidence level of the mappings and whether they can be automatically applied or need manual evaluation or some hybrid technique, such as an AI recommendation followed by a manual approval.

As another example, function 185 can provide vendor-agnostic normalization. For instance, a vendor-agnostic normalized view of CM, PM, and/or FM information (including parameters, counters and alarms) allowing dApps, rApps and xApps to operate seamlessly across different vendors' hardware and/or software including in some embodiments without needing to know the specific details of each vendor's implementation.

As another example, function 185 can provide a comprehensive attribute table. For instance, the attribute table can define various attributes of CM, PM, and FM information such as name, parameter range, value, units, technology, specification, version, hardware, vendor, and/or model. This comprehensive approach ensures accurate and reliable mapping and translation of parameters. Function 185 can operate to improve the efficiency and interoperability of ORAN systems by providing a robust and automated solution for managing CM, PM, and FM information including parameters, counters, and alarms across multiple vendors.

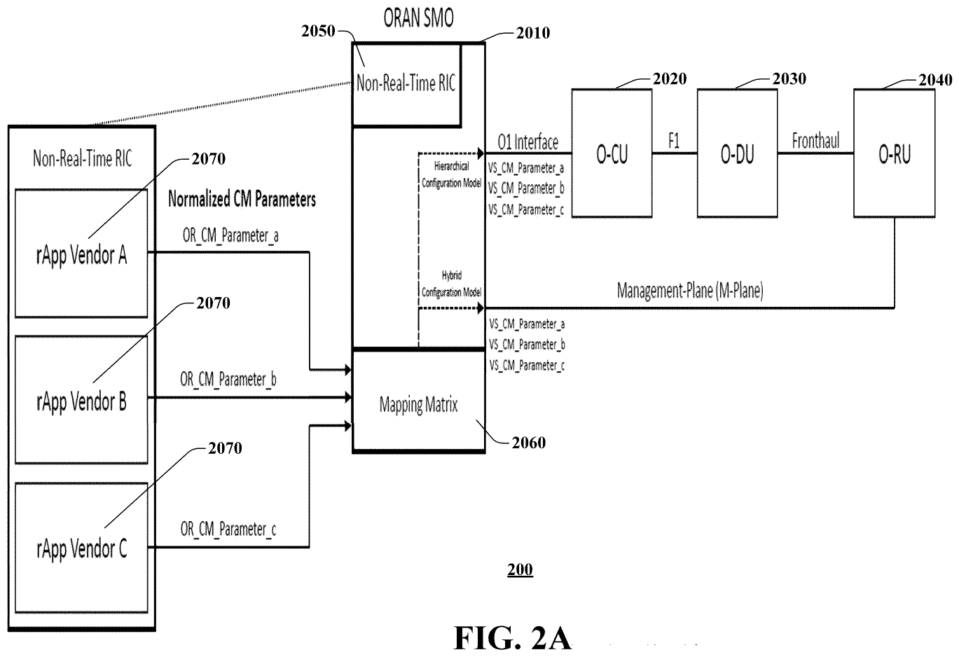

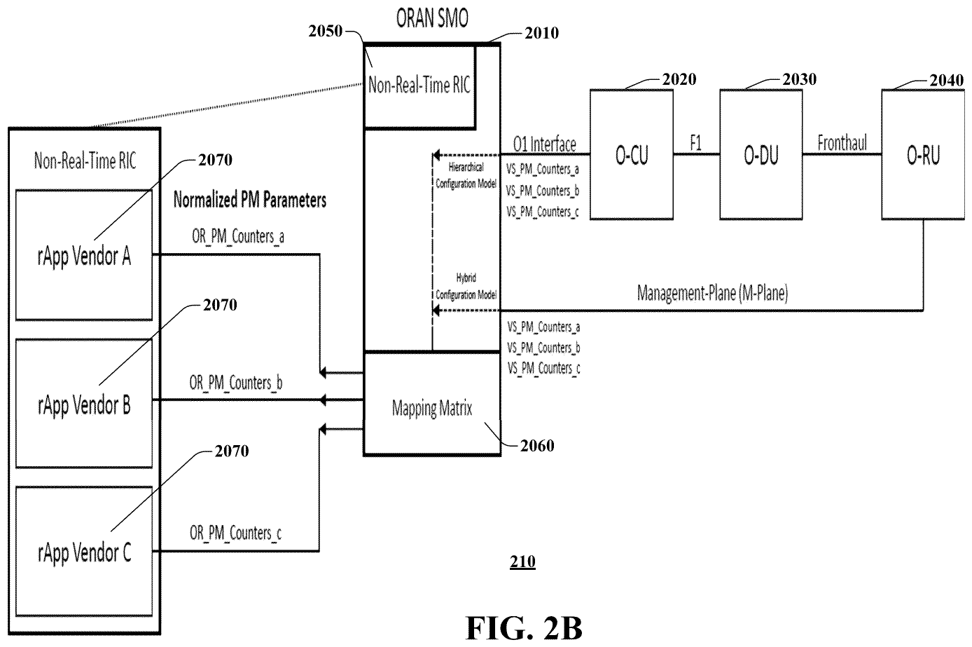

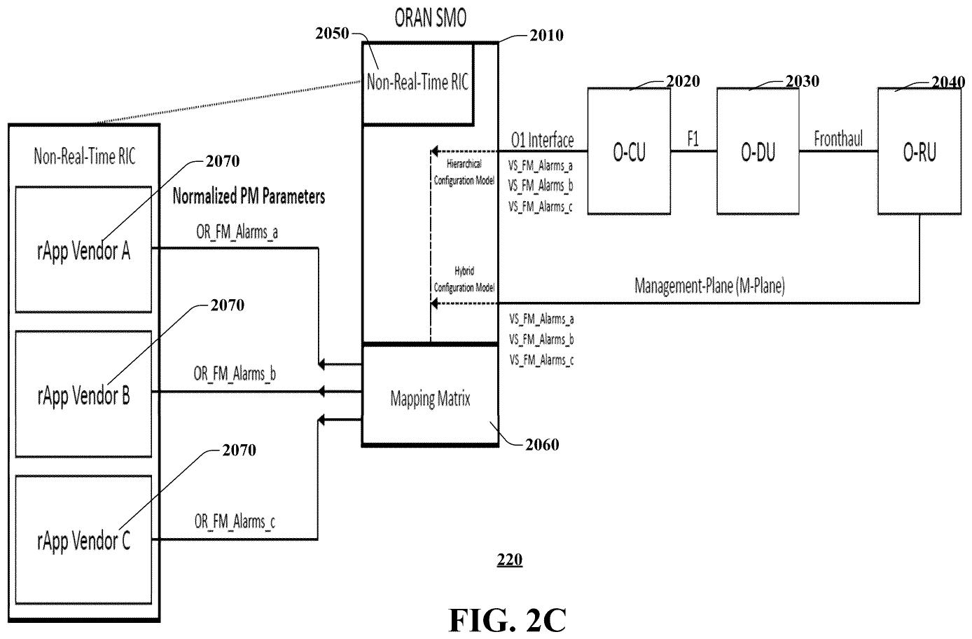

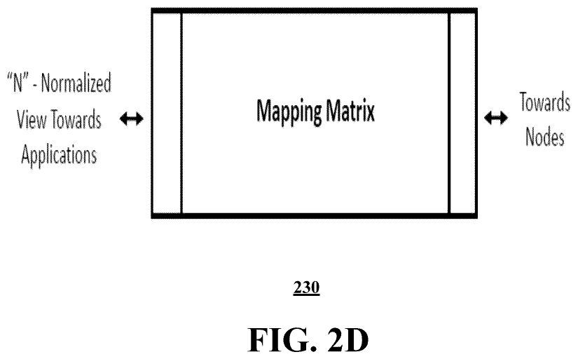

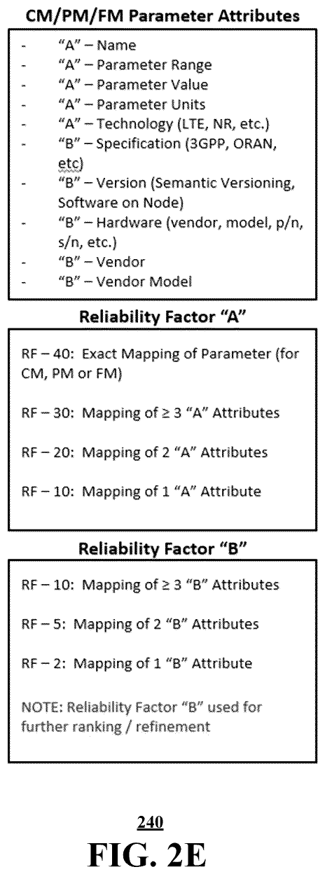

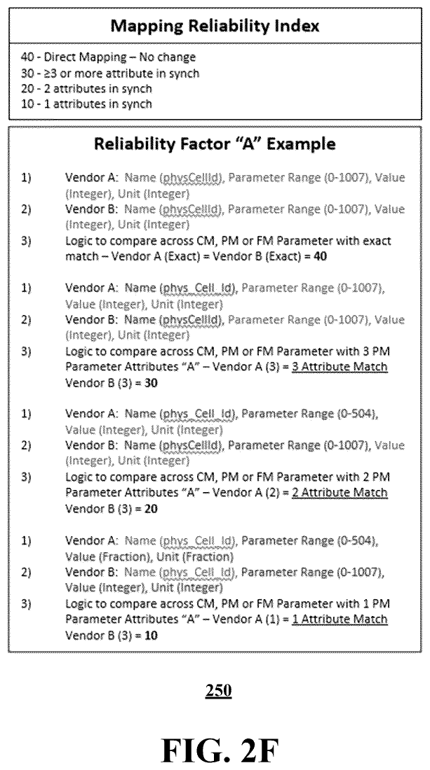

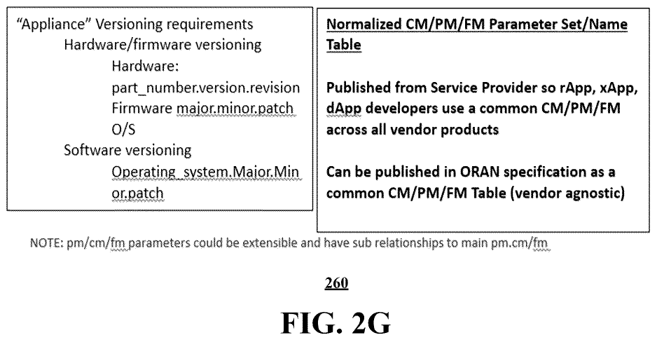

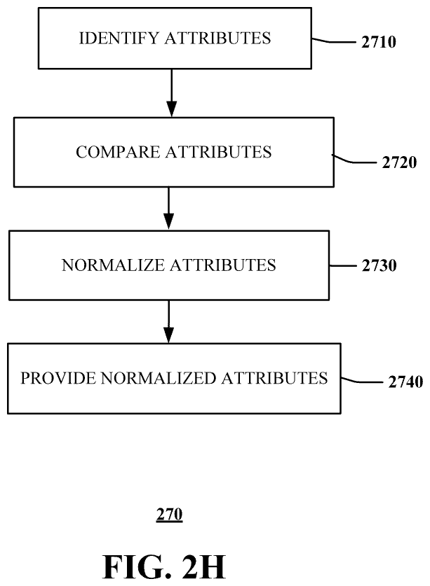

In one or more embodiments, system 100 can include a Non-RT RIC (See e.g., FIGS. 2A-2C) within the ORAN architecture such as within the ORAN SMO 180. It operates in a non-real-time environment, typically with a latency of more than one second, and is responsible for performing tasks that do not require immediate response. The Non-RT RIC plays a crucial role in enhancing the functionality and performance of the RAN by leveraging advanced data analytics, machine learning, and policy management. For example, the Non-RT RIC can use historical data and advanced analytics to optimize network performance and plan for future network expansions. It can analyze traffic patterns, user behavior, and network performance metrics to make informed decisions about resource allocation and network configuration.

As another example, the Non-RT RIC can manage and enforce policies related to RAN operations. These policies can include quality of service (QoS) policies, security policies, and resource allocation policies. The Non-RT RIC ensures that these policies are consistently applied across the network to maintain optimal performance and compliance with SLAs.

As another example, the Non-RT RIC can collect and analyze performance data from the RAN elements. It can identify trends, detect anomalies, and generate insights that help operators understand the network's performance and take proactive measures to address potential issues.

As another example, the Non-RT RIC can leverage ML and AI algorithms to enhance its decision-making capabilities. These technologies enable the Non-RT RIC to learn from historical data, predict future network behavior, and recommend or implement optimizations to improve network performance.

As another example, the Non-RT RIC can detect and diagnose faults in the RAN. It generates alarms for various fault conditions and provides recommendations or actions to resolve issues. By analyzing historical fault data, the Non-RT RIC can also predict potential failures and take preventive measures.

As another example, the Non-RT RIC can host rApps (RAN applications) that provide advanced network management and optimization functionalities. These rApps leverage the data and capabilities of the Non-RT RIC to perform tasks such as network optimization, policy management, and performance monitoring. The Non-RT RIC provides the necessary interfaces and APIs for rApps to interact with the RAN elements and other network components.

As another example, the Non-RT RIC can operate in a vendor-agnostic manner, meaning it can manage and optimize RAN elements from different vendors. This is essential for achieving the interoperability and openness that are central to the ORAN vision. Overall, the Non-RT RIC can be a critical or important component of the ORAN architecture, providing the advanced analytics, policy management, and optimization capabilities needed to enhance the performance and efficiency of the RAN. By operating in a non-real-time environment, the Non-RT RIC can perform complex data analysis and decision-making tasks that contribute to the overall improvement of the network.

In one or more embodiments, system 100 can include a Near-RT RIC within the ORAN architecture. It operates in a near-real-time environment, typically with a latency ranging from 10 milliseconds to one second. The Near-RT RIC is responsible for performing tasks that require quick response times and real-time decision-making to optimize the performance and efficiency of the RAN. The Near-RT RIC can be located at various places including within an edge or regional cloud, centralized or other configurations.

The Near-RT RIC dynamically adjusts the distribution of traffic across the network to ensure that no single cell or node becomes overloaded. This helps maintain optimal network performance and user experience. The Near-RT RIC detects and mitigates interference between cells and users. It can adjust parameters such as transmission power and frequency allocation to minimize interference and improve signal quality. The Near-RT RIC manages the handover process as users move between cells. It ensures seamless transitions and maintains call quality and data session continuity.

The Near-RT RIC allocates network resources, such as bandwidth and transmission power, to users and applications based on real-time demand and network conditions. This helps optimize resource utilization and ensure QoS. The Near-RT RIC enforces QoS policies to prioritize traffic and ensure that critical applications receive the necessary resources. It can adjust parameters in real-time to meet the QoS requirements of different services. The Near-RT RIC can host various applications including xApps (eXtensible Applications) that provide advanced network management and optimization functionalities. These xApps leverage the data and capabilities of the Near-RT RIC to perform tasks such as load balancing, interference management, and mobility management. The Near-RT RIC provides the necessary interfaces and APIs for xApps to interact with the RAN elements and other network components. The Near-RT RIC processes real-time data from the RAN elements to make quick decisions and adjustments. It uses this data to monitor network performance, detect anomalies, and implement optimizations in near-real-time.

Like the Non-RT RIC, the Near-RT RIC is designed to operate in a vendor-agnostic manner, meaning it can manage and optimize RAN elements from different vendors. This is essential for achieving the interoperability and openness that are central to the ORAN vision. Overall, the Near-RT RIC can be a critical or important component of the ORAN architecture, providing the real-time decision-making and optimization capabilities needed to enhance the performance and efficiency of the RAN. By operating in a near-real-time environment, the Near-RT RIC can quickly respond to changing network conditions and ensure optimal network performance and user experience.

Function 185 facilitates the performance of various functions (by various devices and software such as O-CUs, O-DUs, O-RUs, xApps, rApps, dApps) including Configuration Management, Performance Management, and Fault Management through mapping and translation of information such as parameters, counters, and alarms that can be essential for ensuring the efficient operation, monitoring, and troubleshooting of the network.

As an example, CM parameters can be used to configure and manage the network elements. Examples include:—Cell ID: A unique identifier for each cell in the network.—Transmission Power: The power level at which a cell transmits signals. —Frequency Band: The frequency range used for communication.—Neighbor List: A list of neighboring cells for handover purposes.—Access Control Parameters: Parameters that control access to the network, such as barring and priority settings.—Scheduling Parameters: Parameters that define how resources are allocated to users.—Antenna Configuration: Parameters related to the configuration of antennas, such as beamforming settings.

PM parameters can be used to monitor and measure the performance of the network. Examples include:—Throughput: The amount of data transmitted successfully over the network in a given time period.—Latency: The time it takes for a data packet to travel from the source to the destination.—Packet Loss: The percentage of data packets that are lost during transmission.—Signal-to-Noise Ratio (SNR): The ratio of the signal power to the noise power in the communication channel.—Resource Block Utilization: The percentage of resource blocks being used in the network.—Call Drop Rate: The percentage of calls that are dropped unexpectedly.—Handovers: The number of successful and failed handovers between cells.

FM parameters can be used to detect, report, and manage faults in the network. Examples include:—Alarm Severity: The severity level of an alarm, such as critical, major, or minor.—Alarm Type: The type of alarm, such as hardware failure, software error, or connectivity issue.—Alarm Timestamp: The time at which the alarm was generated.—Fault Location: The specific location or component where the fault occurred.—Error Codes: Specific codes that provide information about the nature of the fault.—Event Logs: Logs that record events leading up to and following a fault. —Recovery Actions: Actions taken to recover from a fault, such as restarting a component or rerouting traffic. This information including parameters, counters and/or alarms can be critical for the effective management and operation of an ORAN network, enabling operators to configure the network, monitor its performance, and address any faults that may arise.

In the context of ORAN in system 100, rApps and xApps can be utilized which are software applications designed to enhance the functionality and performance of the RAN by leveraging the capabilities of the RIC. These applications can be part of the ORAN architecture, which aims to create an open and interoperable RAN ecosystem.

As an example, rApps are applications that run on the Non-RT RIC in a non-real-time environment, typically with a latency of more than one second. rApps are used for tasks that do not require immediate response and can benefit from more extensive data analysis and machine learning. Examples of rApp functionalities include: network optimization and planning; policy management; performance monitoring and analytics; energy savings management; and/or fault management and troubleshooting. rApps can leverage the data collected from the RAN and other network elements to make informed decisions and provide recommendations or actions to improve network performance and efficiency. The use of function 185 in mapping and normalizing attributes across various vendors (which can include across various rApps) facilitates the operation of the rApps.

xApps are applications that run on the Near-RT RIC in a near-real-time environment, typically with a latency of 10 milliseconds to one second. xApps are used for tasks that require quick response times and real-time decision-making. Examples of xApp functionalities include: load balancing; interference management; mobility management; resource allocation; and/or QoS management. xApps interact with the RAN elements in near-real-time to optimize network performance and ensure efficient use of resources. The use of function 185 in mapping and normalizing attributes across various vendors (which can include across various xApps) facilitates the operation of the xApps.

Both rApps and xApps play a crucial or important role in the ORAN ecosystem by enabling advanced network management and optimization capabilities, ultimately leading to improved network performance, efficiency, and user experience. In the context of ORAN in system 100, dApps can be utilized which are Distributed Applications. These applications are designed to operate within the ORAN architecture, leveraging the distributed nature of the network to provide various functionalities and services. dApps can be deployed across different network elements and locations, enabling more flexible and efficient network management and optimization. dApps are deployed across multiple network elements, such as O-CUs, O-DUs, and O-RUs. This distributed deployment allows dApps to operate closer to the network edge, reducing latency and improving performance. dApps can scale horizontally by adding more instances across the network. This scalability ensures that the network can handle increased traffic and demand without compromising performance. dApps are designed to work seamlessly with other applications and network elements within the ORAN architecture. They can interact with rApps and xApps hosted on the RIC, both Non-RT RIC and Near-RT RIC. dApps can be developed and deployed to address specific use cases and requirements. They can be tailored to provide various network management and optimization functions, such as load balancing, interference management, mobility management, and more. By leveraging the distributed nature of the ORAN architecture, dApps can provide more granular and localized network management. This enhances the overall efficiency and performance of the network. dApps can incorporate AI and ML algorithms to analyze network data, predict future network behavior, and implement optimizations. This integration enables more intelligent and proactive network management.

Overall, dApps play a crucial or important role in the ORAN ecosystem by providing distributed, scalable, and flexible network management and optimization capabilities. They enhance the performance, efficiency, and reliability of the ORAN network, contributing to the overall goal of creating an open, interoperable, and efficient RAN environment.

For example, system 100 can facilitate in whole or in part identifying parameter attribute information for functions associated with CM, PM, and/or FM performed in a RAN which is associated with a CU, a DU, an RU and/or one or more applications; comparing the parameter attribute information (or a portion(s) thereof) where in some embodiments portion(s) can be associated with different ones of the CU, DU, RU and/or one or more applications resulting in one or more comparisons; adjusting, according to the one or more comparisons, the parameter attribute information (or a portion(s) thereof) resulting in normalized parameter attributes by applying a mapping matrix (or other analysis technique or data structure) to at least a portion of the parameter attribute information; and providing the normalized parameter attributes (or a portion(s) thereof) to the CU, the DU, the RU, and/or the one or more applications, which in some embodiments enable a subsequent function(s) to be performed for the CM, the PM, and/or the FM.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 2A is a block diagram illustrating an example, non-limiting embodiment of a system 200 functioning within the communication network of FIG. 1 in accordance with various aspects described herein. System 200 can include an ORAN SMO 2010 (e.g., similar to ORAN SMO 180 of FIG. 1) which is in communication with a number of network elements or components, three of which are shown which are O-CU 2020, O-DU 2030, and O-RU 2040. Various other network elements, configuration and/or interfaces can be utilized by system 200. System 200 shows a Non-RT RIC 2050 hosting or otherwise utilizing a number of rApps 2070 (three of which are shown). Any number of rApps 2070 can be utilized by the Non-RT RIC 2050 for various functions including CM, PM and FM.

In this example of system 200, rApp vendors may develop rApps 2070 based on a known common CM parameter(s) across all like products (e.g., 5G, LTE, 6G, O-RU, etc.). The rApp 2070 can initiate a CM parameter change. RAN vendors may develop their RAN products (gNB, eNB, 6G Node, O-RU, etc.) with VS (vendor specific) CM parameters, which may not align with 3GPP or ORAN CM parameters.

This can result in an issue that if the rApp vendors develop their product with ORAN and 3GPP specific CM parameters and the RAN vendors don't align with 3GPP and ORAN such as 100% match (i.e., a complete match), there can be misalignment and the rApps may not function correctly or otherwise provide accuracy and efficient management.

In one embodiment, system 200 provides logic or functionality, such as mapping matrix 2060, to ensure: detection of misaligned CM parameters from rApps to the RAN nodes, transport and core elements across vendors; automatic mapping and alignment of CM parameters normalized to all vendors with version control across various new releases (e.g., 3GPP, ORAN, etc.); and/or generation and access to an attribute table to define particular details associated with attributes such as a CM name, parameter range, parameter value, parameter units, technology (e.g., LTE, NR, etc.), Specification (e.g., 3GPP, ORAN, etc.), version (e.g., semantic versioning, software on node, etc.), hardware (vendor, model, p/n, s/n, etc.), vendor, and/or vendor model.

FIG. 2A shows a system for managing CM parameters within an ORAN environment with an O1 Interface, F1 interface, Fronthaul, and Management-Plane (M-Plane). Various information such as OR_CM_Parameter_a, OR_CM_Parameter_b, and OR_CM_Parameter_c can be received by the mapping matrix 2060, where they are mapped and/or normalized to attribute parameters that are aligned with particular network elements (e.g., O-CU 2020, O-DU 2030, O-RU 2040). In this example, the network elements receive the corresponding or correlated attributes illustrated as VS_CM_Parameter_a, VS_CM_Parameter_b, and VS_CM_Parameter_c.

In one embodiment, the mapping matrix 2060 dynamically maps and translates the received CM parameters into a standardized format. For instance, the standardized format can be the VS formats or can be a normalized format that can be further translated in vendor specific formats. In one embodiment, the VS parameters can translate to either format depending on the direction they are coming from or going to. The mapping or translation of this CM parameter can be achieved by one or more of the embodiments. In this example, the parameters are associated with rApps 2070 for the Non-RT RIC 2050. In other embodiments, the parameters can be associated with a Near-RT RIC (not shown) and/or xApps (not shown).

FIG. 2B is a block diagram illustrating an example, non-limiting embodiment of a system 210 functioning within the communication network of FIG. 1 in accordance with various aspects described herein. System 210 can include various elements and functionality including ORAN SMO 2010, O-CU 2020, O-DU 2030, O-RU 2040, Non-RT RIC 2050, mapping matrix 2060 and rApps 2070, which can be utilized by the Non-RT RIC 2050 for various functions including CM, PM and FM.

rApp vendors may develop rApps to look for specific PM counters and measurements for feedback purposes to validate CM parameter changes based on ORAN and 3GPP Specifications. Since the RAN vendors may use ORAN specific, 3GPP specific and VS specific attributes and use various PM measurement/counter names, the rApps may not be able to get or otherwise recognize the feedback from the RAN Nodes. In one embodiment, rApps require feedback from PM, FM or other logs and traces to confirm that the algorithms in the rApps are functioning correctly. The PM or FM or other feedback can prompt a change to the configuration that the rApp would send to the node. If the feedback can't be read due to a lack of normalized view then the rApp can't function correctly, which is a difficulty overcome by the embodiments described herein.

RAN vendors develop their RAN products (e.g., gNB, eNB, 6G Node, O-RU, etc.) with VS (vendor specific) PM parameters, ORAN specific counters and 3GPP specific counters but they may not follow the name specified in ORAN or 3GPP Specifications. In one embodiment, inserting logic (e.g., mapping matrix 2060) will ensure the following: detection of misaligned PM measurements/counters from rApps to the RAN nodes across vendors; automatic mapping and alignment of PM measurements/counters normalized to all vendors; and/or generation of an attribute table to define PM name, parameter range, parameter value, parameter units, technology (e.g., LTE, NR, etc.), Specification (e.g., 3GPP, ORAN, etc), version (e.g., semantic versioning, software on node, etc.), hardware (e.g., vendor, model, p/n, s/n, etc.), vendor, and/or vendor model.

FIG. 2B shows a system for managing PM parameters within an ORAN environment with an O1 Interface, F1 interface, Fronthaul, and Management-Plane (M-Plane). Various information such as VS_PM_Counters_a, VS_PM_Counters_b, and VS_PM_Counters_c can be received by the mapping matrix 2060 from the network elements, where they are mapped and/or normalized to attribute parameters that are aligned with particular rApps 2070. In this example, the rApps receive the corresponding or correlated attributes illustrated as OR_PM_Counters_a, OR_PM_Counters_b, and OR_PM_Counters_c.

In one embodiment, the mapping matrix 2060 dynamically maps and translates the received PM counters into a standardized format. For instance, the standardized format can be the OR formats or can be a normalized format that can be further translated into OR specific formats. In one embodiment, a standardized format can be in a format that is normalized, which can be defined and common across all nodes and tooling. In this example, the counters are associated with the O-CU 2020, O-DU 2030, and O-RU 2040 and provided (after mapping and translation) to the rApps 2070 for the Non-RT RIC 2050. In other embodiments, the counters can be associated with a Near-RT RIC (not shown) and/or xApps (not shown).

FIG. 2C is a block diagram illustrating an example, non-limiting embodiment of a system 220 functioning within the communication network of FIG. 1 in accordance with various aspects described herein. System 220 can include various elements and functionality including ORAN SMO 2010, O-CU 2020, O-DU 2030, O-RU 2040, Non-RT RIC 2050, mapping matrix 2060 and rApps 2070, which can be utilized by the Non-RT RIC 2050 for various functions including CM, PM and FM.

rApp vendors may develop rApps to look for specific FM alarms and for feedback purposes to validate CM parameter changes based on ORAN and 3GPP Specifications. Since the RAN vendors may use ORAN specific, 3GPP specific and VS specific attributes and use various FM alarm names, the rApps may not be able to get or otherwise recognize the feedback from the RAN Nodes. Additionally, there can be a disconnect between FM Alarms across vendors so more managing may be required to map these alarms based on severity. RAN vendors develop their RAN products (e.g., gNB, eNB, 6G Node, O-RU, etc.) with VS (vendor specific) FM alarms, ORAN specific alarms and 3GPP specific alarms but they may not follow the name specified in ORAN or 3GPP Specifications. In one embodiment, inserting logic (e.g., mapping matrix 2060) will ensure the following: detection of misaligned FM alarms from RAN nodes to rApps and other applications across vendors; automatic mapping and alignment of FM alarms normalized to all vendors; and/or generation of an attribute table to define FM name, parameter range, parameter value, parameter units, technology (e.g., LTE, NR, etc.), Specification (e.g., 3GPP, ORAN, etc), version (e.g., semantic versioning, software on node, etc.), hardware (e.g., vendor, model, p/n, s/n, etc.), vendor, and/or vendor model.

FIG. 2C shows a system for managing PM parameters within an ORAN environment with an O1 Interface, F1 interface, Fronthaul, and Management-Plane (M-Plane). Various information such as VS_FM_Alarms_a, VS_FM_Alarms_b, and VS_FM_Alarms_c can be received by the mapping matrix 2060 from the network elements, where they are mapped and/or normalized to attribute parameters that are aligned with particular rApps 2070. In this example, the rApps receive the corresponding or correlated attributes illustrated as OR_FM_Alarms_a, OR_FM_Alarms_b, and OR_FM_Alarms_c.

In one embodiment, the mapping matrix 2060 dynamically maps and translates the received FM alarms into a standardized format. For instance, the standardized format can be the OR formats or can be a normalized format that can be further translated into OR specific formats. In this example, the alarms are associated with the O-CU 2020, O-DU 2030, and O-RU 2040 and provided (after mapping and translation) to the rApps 2070 for the Non-RT RIC 2050. In other embodiments, the counters can be associated with a Near-RT RIC (not shown) and/or xApps (not shown).

FIG. 2D is a block diagram illustrating an example, non-limiting embodiment of a system 230 functioning within the communication network of FIG. 1 in accordance with various aspects described herein. System 230 can be utilized for managing CM, PM and FM information including parameters, counters and alarms within an ORAN environment. The system 230 includes a mapping matrix that can provide a view towards applications (which in one embodiment can be normalized) and a view towards nodes. The mapping matrix dynamically maps and translates received information into a standardized format. This ensures that the information is normalized across different equipment, different versions, different software and/or different vendors.

FIG. 2E depicts an illustrative embodiment of information 240 (e.g., which can be used in a user interface or otherwise part of the system and methodology described herein such as function 185 of FIG. 1) depicting various CM/PM/FM information associated with the system and methodology described herein. The information 240 can include attributes for parameters, counters and alarms, as well as reliability factor data. For example, CM/PM/FM Parameter Attributes are shown and which are assigned a ranking of “A” such as for name, parameter range, parameter value, parameter units, and technology (e.g., LTE, NR, etc.). Other attributes can be assigned a different ranking (e.g., “B”) such as Specification (e.g., 3GPP, ORAN, etc.), version (e.g., semantic versioning, software on node, etc.), hardware (e.g., vendor, model, p/n, s/n, etc.), vendor, and vendor model. The reliability factor “A” section outlines the reliability scores assigned to the mapping of “A” attributes and can dictate or control thresholds to be applied when determining reliability for a mapping such as an exact mapping of a parameter for CM, PM, or FM is assigned a reliability factor of 40. Mapping of three or more “A” attributes is assigned a reliability factor of 30, mapping of two “A” attributes is assigned a reliability factor of 20, and mapping of one “A” attribute is assigned a reliability factor of 10. The reliability factor “B” section details the reliability scores for the mapping of “B” attributes. Mapping of three or more “B” attributes is assigned a reliability factor of 10, mapping of two “B” attributes is assigned a reliability factor of 5, and mapping of one “B” attribute is assigned a reliability factor of 2. The note at the bottom of this section indicates that Reliability Factor “B” is used for further ranking and refinement. Other reliability rankings and techniques can also be utilized, including at different granular levels (e.g., rankings between A through X depending on how significant an attribute is and/or how likely an exact match would occur between different vendors).

FIG. 2F depicts an illustrative embodiment of information 250 (e.g., which can be used in a user interface or otherwise part of the system and methodology described herein such as function 185 of FIG. 1) depicting various data associated with reliability factors and deriving those factors such as for CM/PM/FM information associated with the system and methodology described herein. The information 250 can include reliability index (factors) and rules as to how they are determined (e.g., according to the number of attributes in synch or matching) and/or how mapping is to be processed such as automatic mapping versus manual review or manual intervention/mapping.

As an example, the mapping reliability index includes scores 40, 30, 20, 10 for a reliability factor “A” which details the reliability scores assigned to the mapping of parameter attributes for CM, PM, and FM between pairs of vendors (although the comparison can be made based on any number of vendors including a same vendor such as one that utilized different versions of equipment or software). As an example, a reliability factor of 40 results in direct mapping with no change. When three or more attributes are in sync, the reliability factor is 30. For two attributes in sync, the reliability factor is 20, and for one attribute in sync, the reliability factor is 10. The reliability factor “A” example provides specific scenarios for mapping parameter attributes. In the first scenario, Vendor A and Vendor B have an exact match for the parameter attributes “Name (physCellId),” “Parameter Range (0-1007),” “Value (integer),” and “Unit (integer),” resulting in a reliability factor of 40. In the second scenario, Vendor A and Vendor B have a match for three parameter attributes, resulting in a reliability factor of 30. The third scenario shows a match for two parameter attributes, resulting in a reliability factor of 20. The fourth scenario shows a match for one parameter attribute, resulting in a reliability factor of 10. This provides a structured approach to evaluating the reliability of parameter mappings across different vendors, ensuring consistency and accuracy in the mapping process.

In one or more embodiments, depending of the reliability factor, the methodology may adjust how a mapping is to be performed, such as: an exact match of all attributes resulting in a score/index of 40 and allowing for an automatic mapping/normalization/translation of the attributes; a three attribute match resulting in a score/index of 30 allowing for application of AI/ML modeling to determine the mapping/normalization/translation including of non-matching attributes; and a one attribute match resulting in a score/index of 10 requiring manual review to determine the mapping/normalization/translation including of non-matching attributes. Allowing for a reliability when matching CM/PM or FM across various CM/PM/FM from multiple vendors and matching them to a common CM/PM/FM can be provided by one or more of the embodiment described herein. For example, matching with certainty (or with a desired degree of certainty) and when it is not then a determination can be made as to how reliable and why.

FIG. 2G depicts an illustrative embodiment of information 260, which includes details on versioning requirements and a normalized CM/PM/FM parameter set/name table. This information 260 can be crucial or important for ensuring consistency and interoperability across different vendor products within an ORAN environment. The information 260 can include an outline for the versioning requirements for hardware, firmware, and software. The information 260 can also present a normalized CM/PM/FM parameter set/name table (or other information that should be consistently used by vendors) which can be accessed or provided to vendors (e.g., software developers for rApps, xApps, dApps, equipment manufacturers for network elements such as DUs, CUs and Rus, etc.). As an example, a normalized CM/PM/FM Parameter Set/Name Table can be published from the service provider (or provided in other ways such as through an API) so that rApp, xApp, and dApp (or other) developers and/or equipment manufacturers use a common CM/PM/FM across all vendor products. In one embodiment, this information 260, table or portions thereof can be published in the ORAN specification as a common CM/PM/FM table, ensuring vendor agnosticism. In one embodiment, the PM/CM/FM parameters could be extensible and have sub-relationships to the main PM/CM/FM parameters. This extensibility allows for a more comprehensive and adaptable parameter management system, accommodating various vendor-specific implementations while maintaining a standardized approach. Overall, FIG. 2G illustrates the structured approach to versioning and parameter normalization, which is essential or important for achieving seamless interoperability and efficient management within the ORAN framework.

FIG. 2H depicts an illustrative embodiment of a method 270 in accordance with various aspects described herein. Method 270 can be implemented for managing parameter attributes within a network environment. At 2710, the method 270 identifies parameter attributes. For example, the identified parameter attribute information can be for functions associated with CM, PM, or FM performed in a RAN. The CM, PM, or FM are associated with at least one of a CU, a DU, an RU or other network element of the RAN and with one or more applications. At 2720, the method 270 compares the identified attributes. Portions of the parameter attribute information can be compared, where each of the portions is associated with different ones of the CU, DU, or RU or is associated with different ones of the one or more applications, resulting in one or more comparisons. At 2730, the method 270 normalizes the attributes. For example, a mapping matrix can be used to adjust the parameter attribute information (or a portion thereof) according to the one or more comparisons, resulting in normalized parameter attributes. In one or more embodiments, normalization can be performed in associated with various information such as fields, categories or identifying information as opposed to normalizing particular quantities or values. For example, the categories can help in the normalization if the information is 100% exact or a fraction of the information (e.g., 50% match). The adjusting includes applying a mapping matrix to at least a portion of the parameter attribute information. At 2740, the method 270 provides the normalized attributes. For example, the normalized parameter attributes can be provided to at least one of the CU, the DU, the RU, or the one or more applications to enable continued processing associated with the particular CM, PM or FM functions including a subsequent function(s) to be performed for the at least one of the CM, the PM, or the FM by one of the O-CU, O-DU, O-RU, rApp, xApp, or dApp.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the context of the system and methodology described herein, misaligned alarms from RAN nodes to rApps can include discrepancies or inconsistencies in the FM alarms generated by different RAN nodes when these alarms are interpreted or processed by rApps. These misalignments can occur due to many different reasons including vendor-specific implementations: different RAN vendors may implement FM alarms using their own specific naming conventions, formats, and attributes. This can lead to inconsistencies when rApps, which are designed to work with standardized or normalized alarm parameters, attempt to interpret these vendor-specific alarms. Misalignments can occur due to non-standardized naming conventions: alarms generated by RAN nodes may not follow a standardized naming convention, leading to difficulties in mapping and interpreting these alarms correctly by rApps. For example, an alarm indicating a hardware failure might be named differently by different vendors. Misalignments can occur due to attribute variations: ahe attributes associated with FM alarms, such as severity, timestamp, fault location, and error codes, may vary across different RAN nodes. These variations can cause misalignment when rApps try to process and respond to these alarms. Misalignments can occur due to version and Specification differences: RAN nodes may adhere to different versions of specifications (e.g., 3GPP, ORAN) or may have vendor-specific extensions. This can result in alarms that are not fully compatible with the expectations of rApps, leading to misalignment. Misalignments can occur due to lack of normalization: without a normalized view of FM alarms, rApps may struggle to interpret and act upon alarms generated by different RAN nodes consistently. This lack of normalization can hinder the effective management and resolution of faults.

The system and methodology described herein addresses these misalignments by introducing a dynamic and automatic mapping matrix that normalizes FM alarms across different vendors. This ensures that rApps receive a consistent and standardized view of FM alarms, regardless of the specific implementations by RAN vendors. The mapping matrix dynamically detects misaligned alarms, maps them to a normalized format, and provides a vendor-agnostic view, facilitating seamless operation and interoperability of rApps across different RAN nodes.

Introducing a mapping matrix process or technique enables automatically and dynamically analyzing and mapping various CM/PM/FM information including parameters counters and alarms, and creating a translation table to ensure when developers create or adjust applications (e.g., rApps, xApps and/or dApps) such as based on ORAN specifications, allows developers to work without manual intervention.

Operationally, there are many laborious tasks that can take away valuable time on operations staff to complete tasks which can be automated, and time better spent on more complex tasks. The system and methodology can limit time spent analyzing and mapping the thousands of CM/PM/FM parameters and alarms initially and across all new releases (e.g., ORAN, 3GPP, Vendor Specific). Operationally, this will save many hours spent daily, weekly and monthly on these tasks while building efficiencies into the SMO Platform ensuring that developers spend less time on creating proprietary code to compensate for misalignment across CM/PM/FM parameters and alarms. The system and methodology can be used throughout a network, including in an ORAN SMO.

The system and methodology can save time and money spent on proprietary development and allow a service provider to onboard applications, such as dApps, rApps and xApps quicker. DApps, rApps and xApps can have many types of applications including energy savings management functionality which can save on OPEX immediately in a wireless network. DApps, rApps and xApps can be developed directly to manage various enterprise and commercial services that create revenue for a wireless carrier.

The system and methodology address a gap or inefficiencies associated with analysis, mapping and translation of misaligned information (e.g., CM/PM/FM parameters, counters and alarms) across various RAN, core and transport vendors related to their specific ORAN, 3GPP and vendor specific interpretation of the CM/PM/FM parameters, counters and alarms. The misalignment introduces additional development and more labor that requires ORAN vendors to develop proprietary products that require alignment of CM/PM/FM parameters and alarms for use in ORAN dApps, xApps and rApps. Today, an operator would need to manage and orchestrate all dApps, rApps and xApps individually instead of managing all with the system and methodology described herein.

The system and methodology provide for inserting logic into a mapping matrix which will ensure or provide for the detection of misaligned CM/PM/FM information including parameters, counters and alarms, and normalization of the CM/PM/FM information including parameters, counters and alarms for use by dApps, xApps and rApps across RAN nodes, transport and core elements. In one or more embodiments, an attribute table will be used for CM/PM/FM information including parameters, counters and alarms to match and rank CM/PM/FM information including parameters, counters and alarms for reliability. In one or more embodiments, a reliability index can be used to determine the accuracy of the mapping and translations of the CM/PM/FM information including parameters, counters and alarms across all vendors.

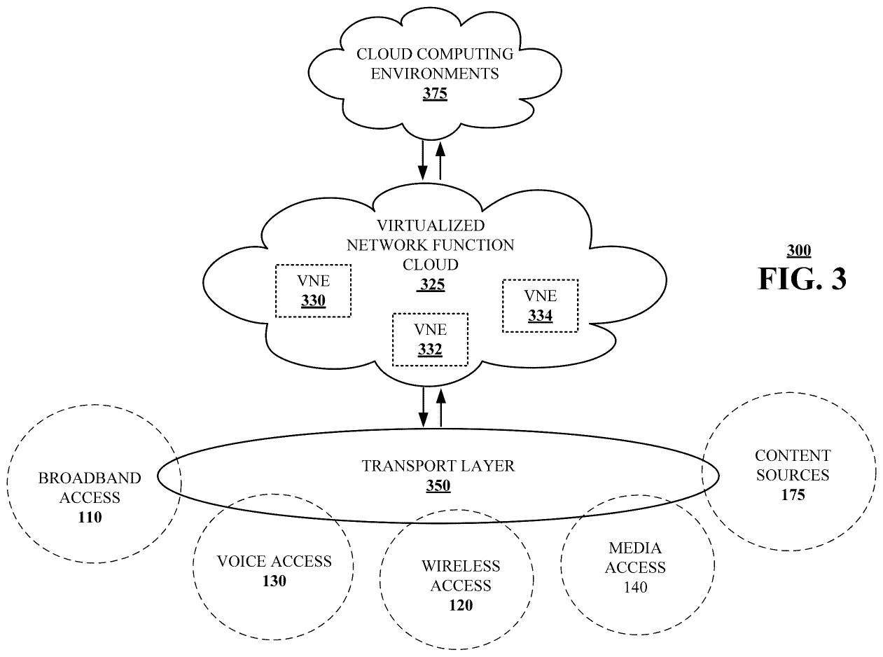

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems, functions and methodology described herein. For example, virtualized communication network 300 can facilitate in whole or in part identifying parameter attribute information for functions associated with CM, PM, and/or FM performed in a RAN which is associated with a CU, a DU, an RU and/or one or more applications; comparing the parameter attribute information (or a portion(s) thereof) where in some embodiments portion(s) can be associated with different ones of the CU, DU, RU and/or one or more applications resulting in one or more comparisons; adjusting, according to the one or more comparisons, the parameter attribute information (or a portion(s) thereof) resulting in normalized parameter attributes by applying a mapping matrix (or other analysis technique or data structure) to at least a portion of the parameter attribute information; and providing the normalized parameter attributes (or a portion(s) thereof) to the CU, the DU, the RU, and/or the one or more applications, which in some embodiments enable a subsequent function(s) to be performed for the CM, the PM, and/or the FM.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

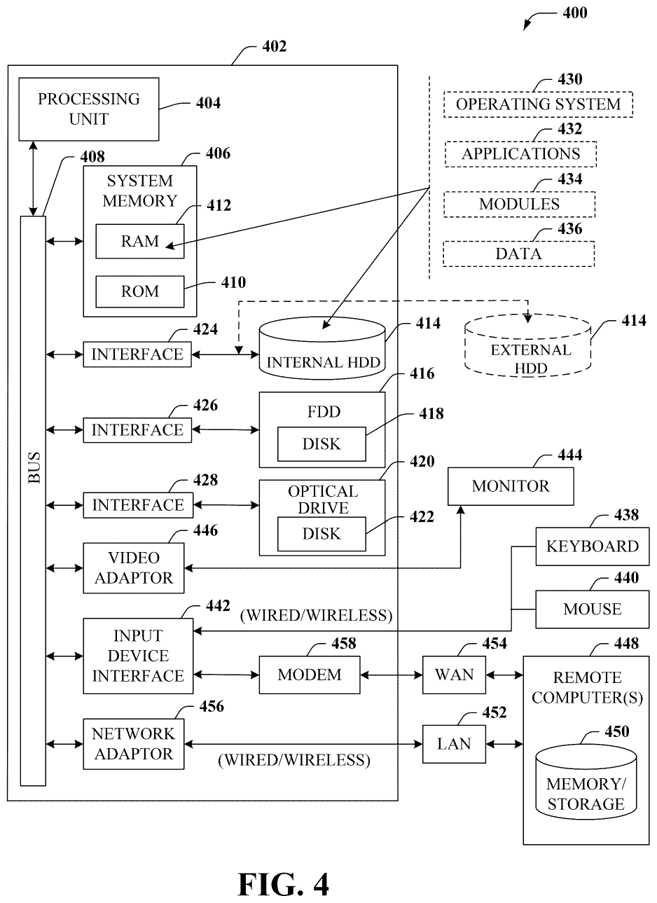

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software.

For example, computing environment 400 can facilitate in whole or in part identifying parameter attribute information for functions associated with CM, PM, and/or FM performed in a RAN which is associated with a CU, a DU, an RU and/or one or more applications; comparing the parameter attribute information (or a portion(s) thereof) where in some embodiments portion(s) can be associated with different ones of the CU, DU, RU and/or one or more applications resulting in one or more comparisons; adjusting, according to the one or more comparisons, the parameter attribute information (or a portion(s) thereof) resulting in normalized parameter attributes by applying a mapping matrix (or other analysis technique or data structure) to at least a portion of the parameter attribute information; and providing the normalized parameter attributes (or a portion(s) thereof) to the CU, the DU, the RU, and/or the one or more applications, which in some embodiments enable a subsequent function(s) to be performed for the CM, the PM, and/or the FM.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

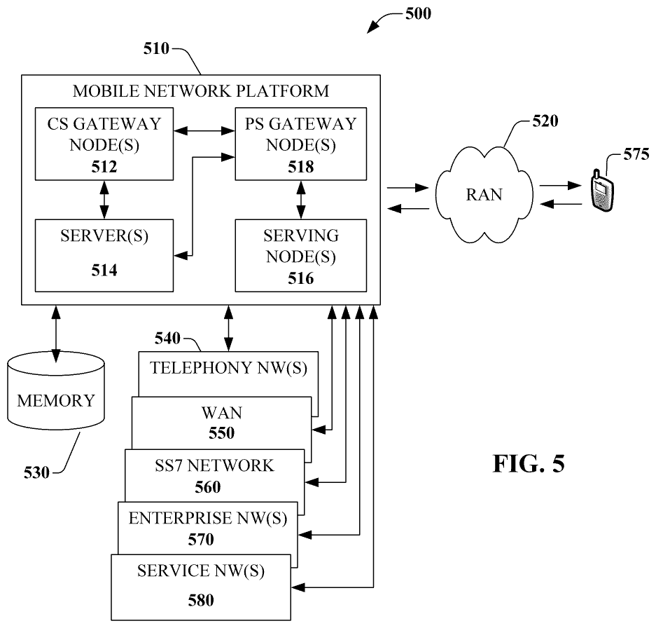

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identifying parameter attribute information for functions associated with CM, PM, and/or FM performed in a RAN which is associated with a CU, a DU, an RU and/or one or more applications; comparing the parameter attribute information (or a portion(s) thereof) where in some embodiments portion(s) can be associated with different ones of the CU, DU, RU and/or one or more applications resulting in one or more comparisons; adjusting, according to the one or more comparisons, the parameter attribute information (or a portion(s) thereof) resulting in normalized parameter attributes by applying a mapping matrix (or other analysis technique or data structure) to at least a portion of the parameter attribute information; and providing the normalized parameter attributes (or a portion(s) thereof) to the CU, the DU, the RU, and/or the one or more applications, which in some embodiments enable a subsequent function(s) to be performed for the CM, the PM, and/or the FM.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

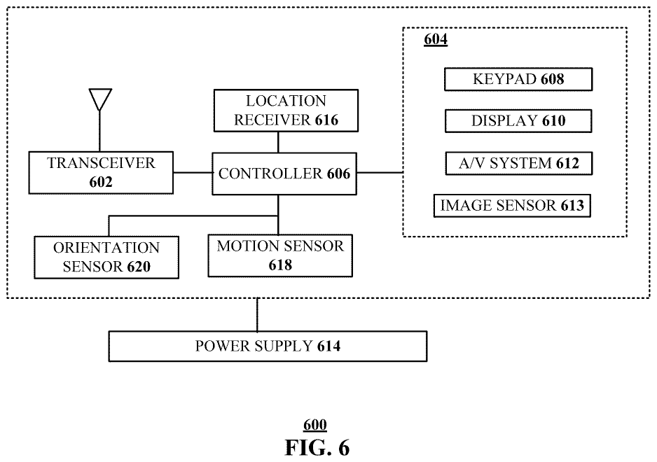

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part identifying parameter attribute information for functions associated with CM, PM, and/or FM performed in a RAN which is associated with a CU, a DU, an RU and/or one or more applications; comparing the parameter attribute information (or a portion(s) thereof) where in some embodiments portion(s) can be associated with different ones of the CU, DU, RU and/or one or more applications resulting in one or more comparisons; adjusting, according to the one or more comparisons, the parameter attribute information (or a portion(s) thereof) resulting in normalized parameter attributes by applying a mapping matrix (or other analysis technique or data structure) to at least a portion of the parameter attribute information; and providing the normalized parameter attributes (or a portion(s) thereof) to the CU, the DU, the RU, and/or the one or more applications, which in some embodiments enable a subsequent function(s) to be performed for the CM, the PM, and/or the FM.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
identifying, by a processing system including a processor, parameter attribute information for functions associated with at least one of Configuration Management (CM), Performance Management (PM), or Fault Management (FM) performed in a Radio Access Network (RAN), wherein the CM, PM or FM are associated with at least one of a Central Unit (CU), a Distributed Unit (DU) or a Radio Unit (RU) of the RAN and with one or more applications;
comparing, by the processing system, portions of the parameter attribute information, wherein each of the portions are associated with different ones of the CU, DU, or RU or are associated with different ones of the one or more applications resulting in one or more comparisons;
adjusting, by the processing system and according to the one or more comparisons, the parameter attribute information resulting in normalized parameter attributes, wherein the adjusting includes applying a mapping matrix to at least a portion of the parameter attribute information; and
providing, by the processing system, the normalized parameter attributes to at least one of the CU, the DU, the RU, or the one or more applications to enable a subsequent function to be performed for the at least one of the CM, the PM, or the FM.

2. The method of claim 1, wherein the identifying of the parameter attribute information includes applying Artificial Intelligence (AI) modeling to parse the parameter attribute information from among other information collected for the functions.

3. The method of claim 2, wherein the parameter attribute information includes parameters provided by the one or more applications, counters provided by at least one of the CU, DU or RU, or alarms provided by at least one of the CU, DU or RU.

4. The method of claim 3, wherein the adjusting the parameter attribute information comprises:
determining a reliability factor for each of the one or more comparisons; and
determining whether to apply the mapping matrix to at least some of the portions of the parameter attribute information based on the reliability factor satisfying a threshold.

5. The method of claim 4, wherein the threshold is a complete match.

6. The method of claim 4, comprising providing at least some others of the portions of the parameter attribute information to a user interface for user evaluation.

7. The method of claim 1, wherein the parameter attribute information includes at least one of a parameter name, a parameter range, a parameter value, a parameter unit, a technology, a specification, a version, a hardware, a vendor, or a model.

8. The method of claim 1, comprising generating, by the processing system, reports for CM, PM, and FM functions according to the parameter attribute information.

9. The method of claim 1, wherein the one or more applications include at least one of an rApp, an xApp, or a dApp.

10. The method of claim 1, wherein the one or more applications operate in one of a non-real-time RAN Intelligent Controller (RIC) or a near-real-time RIC.

11. The method of claim 1, comprising generating, by the processing system, a report including the normalized parameter attributes that is accessible at a user interface associated with a software developer of the one or more applications.

12. A device, comprising:
a processing system including a processor; and
a memory that stores executable instructions that, when executed by the processing system, facilitate performance of operations, the operations comprising:
receiving data from an application associated with at least one of Configuration Management (CM), Performance Management (PM), or Fault Management (FM) performed in a Radio Access Network (RAN), wherein the CM, PM or FM are associated with at least one of a Central Unit (CU), a Distributed Unit (DU) or a Radio Unit (RU) of the RAN;
identifying parameter attribute information from the data by applying Artificial Intelligence (AI) modeling to the data;
comparing portions of the parameter attribute information resulting in one or more comparisons;
adjusting, according to the one or more comparisons, the parameter attribute information resulting in normalized parameter attributes, wherein the adjusting includes applying a mapping matrix to at least a portion of the parameter attribute information; and
providing the normalized parameter attributes to at least one of the CU, the DU, or the RU to enable a subsequent function to be performed for the at least one of the CM, the PM, or the FM.

13. The device of claim 12, wherein the application is one of an rApp or an xApp.

14. The device of claim 12, wherein the adjusting the parameter attribute information comprises:
determining a reliability factor for each of the one or more comparisons; and
determining whether to apply the mapping matrix to at least some of the portions of the parameter attribute information based on the reliability factor satisfying a threshold.

15. The device of claim 14, wherein the threshold is a complete match.

16. The device of claim 14, wherein the operations further comprise providing at least some others of the portions of the parameter attribute information to a user interface for user evaluation.

17. The device of claim 14, wherein the parameter attribute information includes at least one of a parameter name, a parameter range, a parameter value, a parameter unit, a technology, a specification, a version, a hardware, a vendor, or a model.

18. A non-transitory machine-readable medium, comprising executable instructions that, when executed by a processing system including a processor, facilitate performance of operations, the operations comprising:
receiving data from at least one of a Central Unit (CU), a Distributed Unit (DU) or a Radio Unit (RU) of a Radio Access Network (RAN), the data being associated with Configuration Management (CM), Performance Management (PM), or Fault Management (FM) performed in the RAN;
identifying parameter attribute information from the data by applying Artificial Intelligence (AI) modeling to the data;
comparing portions of the parameter attribute information resulting in one or more comparisons;
adjusting, according to the one or more comparisons, the parameter attribute information resulting in normalized parameter attributes, wherein the adjusting includes applying a mapping matrix to at least a portion of the parameter attribute information; and
providing the normalized parameter attributes to a plurality of applications to enable subsequent functions to be performed for the at least one of the CM, the PM, or the FM, wherein the plurality of applications include at least one of rApps or xApps.

19. The non-transitory machine-readable medium of claim 18, wherein the operations further comprise claim 18, wherein the adjusting the parameter attribute information comprises:
determining a reliability factor for each of the one or more comparisons; and
determining whether to apply the mapping matrix to at least some of the portions of the parameter attribute information based on the reliability factor satisfying a threshold.

20. The non-transitory machine-readable medium of claim 19, wherein the threshold is a complete match.
